(19) United States
(12) Patent Application Publication
(10) Pub. No.: US 2015/0264005 A1
(43) Pub. Date: Sep. 17, 2015

(54) Method of Facilitating Object Oriented Ephemeral Conversations

(71) Applicant: TigerText, Inc., Santa Monica, CA (US)

(72) Inventors: Brad Brooks, Beverly Hills, CA (US); Sumeet Bhatia, Los Angeles, CA (US); Sean Whiteley, Pacific Palisades, CA (US)

(21) Appl. No.: 14/658,362

(22) Filed: Mar. 16, 2015

Related U.S. Application Data
(60) Provisional application No. 61/953,135, filed on Mar. 14, 2014.
(60) Provisional application No. 61/953,144, filed on Mar. 14, 2014.

(51) Int. Cl. H04L 12/58; G06F 3/0484; H04L 29/06

(52) U.S. Cl. CPC H04L 51/32; H04L 65/403; G06F 3/0484

(57) ABSTRACT

A method of facilitating an ephemeral conversation surrounding an object, including presenting a user interface proximate to the object, to permit interaction with an ephemeral conversation widget; presenting a user interface for providing credentials to the ephemeral conversation widget; presenting a user interface for beginning a conversation with at least one contact, such that the conversation is displayed as associated with the object; and removing the conversation from the display proximate to the object after an expiration period.

This application claims the benefit of U.S. patent application Ser. No. 61/953,135 filed on Mar. 14, 2014 and U.S. patent application Ser. No. 61/953,144, filed on Mar. 14, 2014, which are hereby incorporated by reference in their entirety.

### BACKGROUND

U.S. patent application Ser. Nos. 13/063,763 and 13/046,862, filed by the applicant hereof and incorporated herein by reference, describe a system for ephemeral messaging, whereby individuals can have conversations that “self-destruct” or disappear after a predetermined period of time. As discussed in more detail therein, these messages are different from traditional electronic mail or text messaging systems, which are stored persistently.

As an alternative to e-mail and text messaging, social media and other services that promote conversation are proprietary. They require users to interact via a particular website which is manually curated, and users are required to register with a particular site, or likely multiple sites, to converse with each site's users.

Some of these social media services have promoted widgets that are embedded in other web pages, such as news sites, which contain a link or button allowing the user to begin a conversation on the social media service relating to the object. However, although the original object is linked or displayed, clicking the button merely begins a conversation on the aforementioned social media service, where the conversation is asynchronous and persistent, and walled off inside the social media service itself.

Therefore it would be useful in the art to have the ability to begin an object oriented conversation, centering on an object such as a news story, where the object is the focus, the conversation occurs in real time, and then it is deleted. This simulates in person casual conversation, where no records are kept.

### SUMMARY OF THE INVENTION

The present disclosure describes a method of facilitating an ephemeral conversation surrounding an object, including presenting a user interface proximate to the object, to permit interaction with an ephemeral conversation widget; presenting a user interface for providing credentials to the ephemeral conversation widget; presenting a user interface for beginning a conversation with at least one contact, such that the conversation is displayed as associated with the object; and removing the conversation from the display proximate to the object after an expiration period.

DESCRIPTION OF THE FIGURES

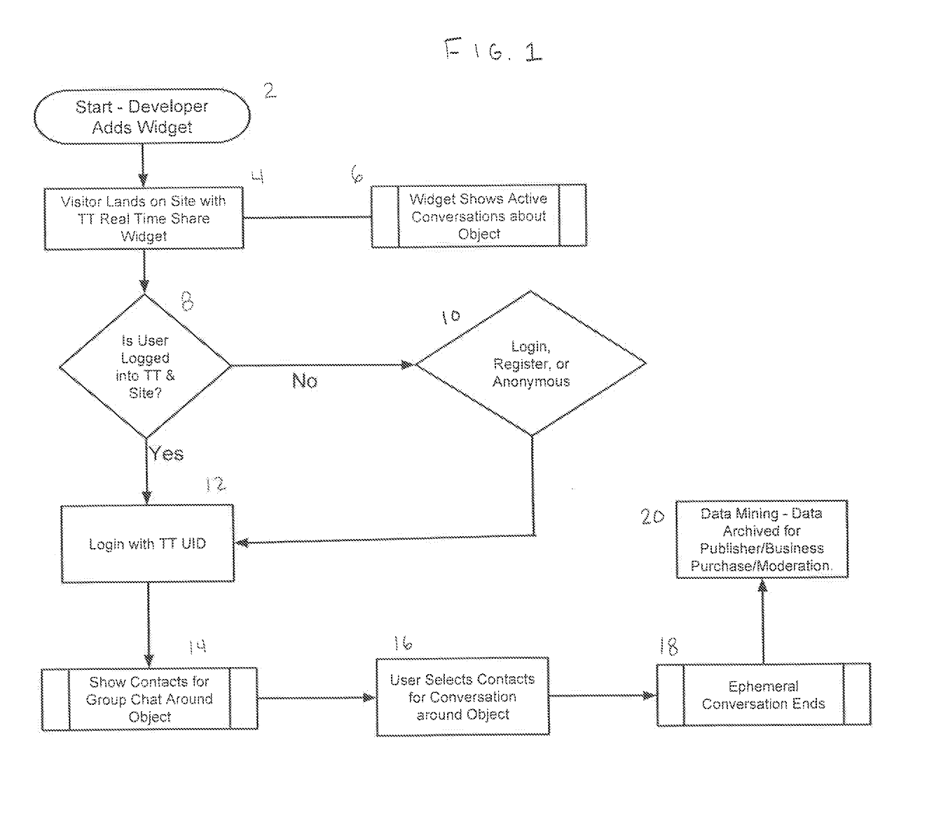

FIG. 1 is a flow diagram in accordance with one aspect of the present invention.

### DETAILED DESCRIPTION OF THE INVENTION

In one aspect of the present invention, publishers of web sites can download code or a software development kit (SDK) to use a widget. By adding some code to their site, the widget will be displayed on any website or application and tied to any object within the website or application. Examples of an object include: a news story, an encyclopedia article, an entry in a database, a blog post, a social profile (e.g. an online dating profile), a file or document, or any other similar object.

The code permits anyone to start or join a conversation around an object. Users who have been verified through the system of this aspect of the present invention will show as such. Users will be asked to either provide credentials or start an anonymous conversation. Users may also be presented with the option to create a set of credentials.

In one aspect of the present invention, anonymous users can create an open conversation that anyone can join, which will be linked to the object structurally via software and/or visually on the web page or application. Conversations happening around a particular object will be displayed so that others can join, and/or the number of active conversations will be shown.

Registered users can join or create public conversations, or they can create private conversations among people from their directory or other friends.

Publishers who use the widget can create controls for conversations revolving around their object. For example, the publisher of an article can decide whether public conversations, private conversations, both, or neither would be allowed for a particular object, and/or site-wide. They can, in one aspect, decide to allow or prohibit anonymous users. They can also moderate the content, and may in one aspect be able to receive or retain it.

End users get the instant gratification of a real time conversation around an object, mimicking the informal discussion about news stories that occurs daily in person. In this aspect, the present invention unifies the mobile and desktop experience by replacing static content that exists today with dynamic object-oriented conversations that are ephemeral.

Turning now to FIG. 1, in Step 2 a developer adds a widget to his web site, app, or other content delivery system where discreet objects are shown and referenced. Subsequently, in Step 4 a visitor lands on the site showing the widget, which might in one aspect manifest itself visually as a button. The widget shows a graphical representation of active conversations about an object, in Step 6. In Step 8, when the visitor attempts to interact with the widget, the widget determines whether the visitor is logged in to the site he/she is visiting, and/or to the provider of the ephemeral messaging service. If the visitor is not logged in (“No’ Step 8), the user is given the option to log in, register, or proceed anonymously in Step 10. Next, (“Yes” Step 8) the visitor is able to log in with his or her credentials from the ephemeral messaging service provider at Step 12. In Step 14, the visitor is shown contacts from various sources, representing other people with whom he can begin a conversation or participate in an active one. In Step 16, the visitor then selects contacts and begins the conversation via the user interface. The conversation is ephemeral. Once the conversation ends (Step 18), the conversation can be deleted, or it can be archived in Step 20. In one aspect of the invention, the data in the conversation can be mined.

What is claimed is:

1. A method of facilitating an ephemeral conversation surrounding an object, comprising the steps of:
a. presenting a user interface proximate to the object, to permit interaction with an ephemeral conversation widget;
b. presenting a user interface for providing credentials to the ephemeral conversation widget;
c. presenting a user interface for beginning a conversation with at least one contact, such that the conversation is displayed as associated with the object; and
d. removing the conversation from the display proximate to the object after an expiration period.
